(19) United States
(12) Patent Application Publication
(10) Pub. No.: US 2011/0083707 A1
(43) Pub. Date: Apr. 14, 2011

(54) DEVICE FOR CLEANING DRAIN CONDUITS

(76) Inventor: German Beltran, Oceanside, CA (US)

(21) Appl. No.: 12/997,504

(22) PCT Filed: Jun. 30, 2009
(86) PCT No.: PCT/US09/49307

§ 371 Date: Dec. 10, 2010

(30) Foreign Application Priority Data
Jun. 30, 2008 (US) 61/133619

(51) Int. Cl. B08B 3/00

(52) U.S. Cl. 134/198; 134/22.11

(57) ABSTRACT

Devices for cleaning drains and/or conduits and methods of using the same. In one example, an overflow drain cleaning device (7) includes a tube (9), a connecting adaptor (8) connected to one end of the tube (9), and a spray tip (23) connected to another end of the tube (9). The spray tip (23) may include an internal cavity or lumen and at least one (aperture 16) configured to spray or project liquid away from the spray tip. In one example, the connecting adaptor (8) can be threadably coupled to a faucet and establishes fluid communication between the connecting adaptor (8) and the spray tip (23).

### CROSS-REFERENCE TO RELATED APPLICATIONS

This application claims priority to U.S. Provisional Application No. 61/133,619 filed on Jun. 30, 2008, titled “SINK SMELL ELIMINATOR,” which is hereby expressly incorporated by reference in its entirety.

### BACKGROUND

1. Field

Embodiments disclosed herein relate generally to devices for cleaning overflow drains and conduits in sinks. More specifically, certain embodiment concern devices that can be coupled with a source of pressurized liquid, for example, a faucet, to receive a flow of liquid therefrom and that can direct the liquid into an overflow drain or conduit to clean residue from the drain or conduit.

2. Description of the Related Art

Many household and commercial sinks, basins, and bath tubs have overflow drains or conduits. Contaminants, for example, food products, hair, dirt, and/or other materials, may accumulate in overflow drains or conduits over time and result in blockages, the formation of residues, and/or undesirable odors. Embodiments disclosed herein relate to devices and methods for cleaning contaminants, residues, and/or odors from overflow drains or conduits.

### SUMMARY

The devices and methods disclosed herein each have several aspects, no single one of which is solely responsible for their desirable attributes. Without limiting the scope of the claims, some prominent features will now be discussed briefly. Numerous other embodiments are also contemplated, including embodiments that have fewer, additional, and/or different components, steps, features, objects, benefits, and advantages. The components, aspects, and steps may also be arranged and ordered differently. After considering this discussion, and particularly after reading the section entitled “Detailed Description of Certain Embodiments,” one will understand how the features of the devices and methods disclosed herein provide advantages over other known devices and methods.

In one embodiment, an overflow conduit cleaning device may comprise a tube comprising a distal end and a proximal end. The tube may be formed of a flexible material and may have a lumen running from the proximal end to the distal end. The device may include a connecting adaptor coupled to the proximal end of the tube and may be configured to establish fluid communication between a pressurized source of liquid and the lumen. The device may also include a spray tip having a longitudinal axis and an internal cavity with at least one aperture connecting the internal cavity with a surface of the spray tip. The spray tip may be coupled with the distal end of the tube to establish fluid communication between the lumen and the internal cavity. At least one aperture may be configured to project liquid provided by a pressurized source of liquid out of the spray tip.

In certain aspects the tube may comprise of rubber. The tube may have an outer diameter of about one-quarter of an inch and/or have a length of about 18 inches. The connecting adaptor may be configured to threadably engage a spout and/or faucet. The connecting adaptor may comprise brass. The spray tip and/or connector and/or tube adaptor may comprise of the same material. The tube and connector adaptor may also comprise the same material. The pressurized source of liquid used may comprise a faucet.

In other aspects, the spray tip may comprise at least one forward aperture and may or may not further comprise at least one side-facing aperture. The spray tip may comprise at least one side-facing aperture that may be further configured to project liquid from the internal cavity in a direction that is generally normal to the longitudinal axis and/or project liquid from the internal cavity at an angle that is between about 15° and about 75° relative to the longitudinal axis. The spray tip may comprise a plurality of side-facing apertures that may be generally aligned with one another about the longitudinal axis. A plurality of side-facing apertures may be generally equally spaced around a perimeter of the spray tip. The spray tip may have a diameter that is less than about one quarter of an inch and/or be configured to fit within an overflow cavity of a sink. The device may include a spaying and/or a plugging assembly. Said plugging assembly may create a seal between the plugging surface and the overflow drain. The device may also comprise a rotating coupling. Such coupling may permit rotation of at a least a part of the tube relative to the connecting adaptor. The spray tip may also be configured to rotate relative to a connecting adaptor.

Another embodiment, for example, may comprise of a first means for directing a liquid from one location to another location, a second means for connecting the first means to a source of pressurized liquid; and a third means for projecting liquid from the first means.

An additional embodiment, for example, may comprise a primary tube comprising a distal end and a proximal end, a connecting adaptor coupled to the proximal end of the primary tube and configured to establish fluid communication between a pressurized source of liquid and the primary tube, a connector comprising an inlet and a plurality of outlets, the connector configured to evenly distribute a liquid input into the inlet between the plurality of outlets, a plurality of secondary tubes, each secondary tube having a longitudinal axis, a first end, and a second end, the first end of each secondary tube being coupled to an outlet to establish fluid communication between the secondary tube and the connector, the second ends of each tube comprising an aperture that is disposed on a plane that lies at an angle relative to the longitudinal axis.

In certain aspects, the device may have a quantity of outlets that are equal to the quantity of secondary tubes. The device may comprise of two or more secondary tubes. The second end of such secondary tubes may comprise an aperture that may or may not be disposed on a plane that lies at an angle of about 45° relative to the longitudinal axis of the secondary tube. The device may comprise a plurality of spray tips each having an internal cavity with at least one projectile aperture connecting the internal cavity with a surface of the spray tip. Each spray tip may be coupled with a second end of a secondary tube, wherein fluid communication may be established between the secondary tubes and the spray tips.

In other embodiments, a method of cleaning a sink overflow drain and conduit may comprise providing an embodiment of the device and inserting at least one spray tip of said device into an overflow drain opening. Fluid may be provided into the device at a flow or velocity sufficient to remove any undesired material from the drain and/or overflow conduit. In certain aspects, the spray tip may be inserted sufficient to permit the fluid to contact the undesired material with sufficient flow or velocity while not permitting fluid to escape out of the overflow drain opening.

In some embodiments, a method of cleaning an overflow conduit may comprise providing an embodiment of a cleaning device, inserting at least one spray tip into an overflow drain opening, and providing a fluid into the device at a flow or velocity such that the fluid is projected from the at least one spray tip in a plurality of directions.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1A is a perspective cut-away view of one example of an embodiment of a drain cleaning device coupled with a faucet and inserted into an overflow drain of a sink.

FIG. 1B is a perspective cut-away view of the configuration shown in FIG. 1A with liquid travelling through the drain cleaning device.

FIG. 2A is a top plan view of one example of an embodiment of a drain cleaning device including a spraying assembly.

FIG. 2B is a close-up view of a portion of the spraying assembly shown in FIG. 2A.

FIG. 3A is a top plan view of one example of an embodiment of a drain cleaning device including a spraying assembly.

FIG. 3B is a close-up view of a portion of the spraying assembly shown in FIG. 3A.

FIG. 4 is a top plan view of one example of an embodiment of a drain cleaning device.

FIG. 5 is a top plan view of an example of a drain cleaning device according to one embodiment.

### DETAILED DESCRIPTION OF CERTAIN EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Liquid overflow may collect in overflow drains or conduits of sinks, basins, bath tubs, and/or other containers when the primary drain of the container is covered, clogged, and/or otherwise blocked, or when the rate of liquid input into the container is greater than the rate of volume exiting the container. Overflow drains are often located higher than the primary drain near the rim or lip of the container. Liquid that rises to the level of the overflow drain may be redirected via an internal conduit or path to the primary drain or similar plumbing that routes the excess liquid away from the container.

Liquid overflow may contain contaminants, for example, hair, dirt, food, and/or other particulate matter that may collect in overflow drains or conduits over time and lead to clogs and /or residues. In addition, overflow drains and the channels connected to them can be substantially moist or humid, and poorly ventilated. These conditions can create a favorable atmosphere for the growth of bacteria, mold, and/or fungus which can emit unfavorable smells or odors from the drain. Various embodiments disclosed herein can utilize, for example, readily available household water pressure to effectuate the removal of contaminants and/or residues from overflow drains or conduits to prevent blockages and/or undesirable odors. It should be appreciated that other sources of liquid or fluid also can be used in addition to household water, for example, air or gas. In some embodiments, a pressurized tank, bottle, or other container can be attached to the devices.

Several non-limiting examples of embodiments will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments. Furthermore, embodiments can include several novel features, no single one of which is solely responsible for its desirable attributes or which is essential to practicing the technology herein described.

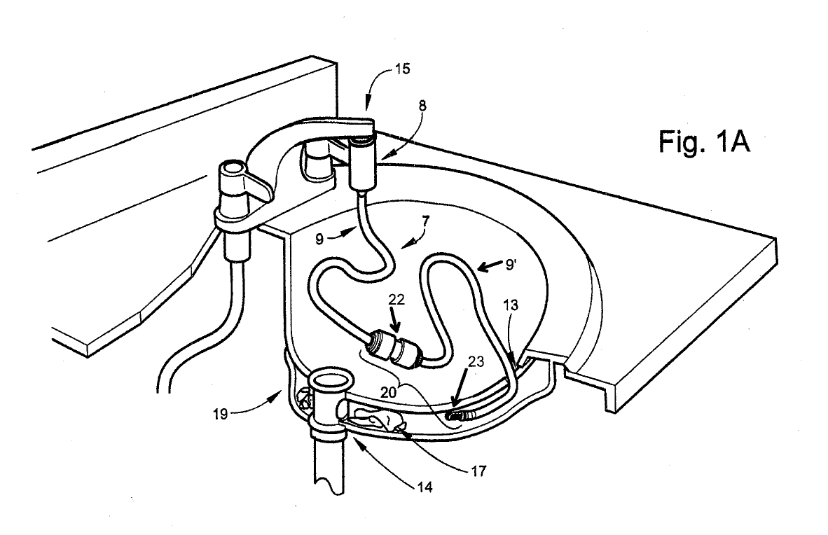

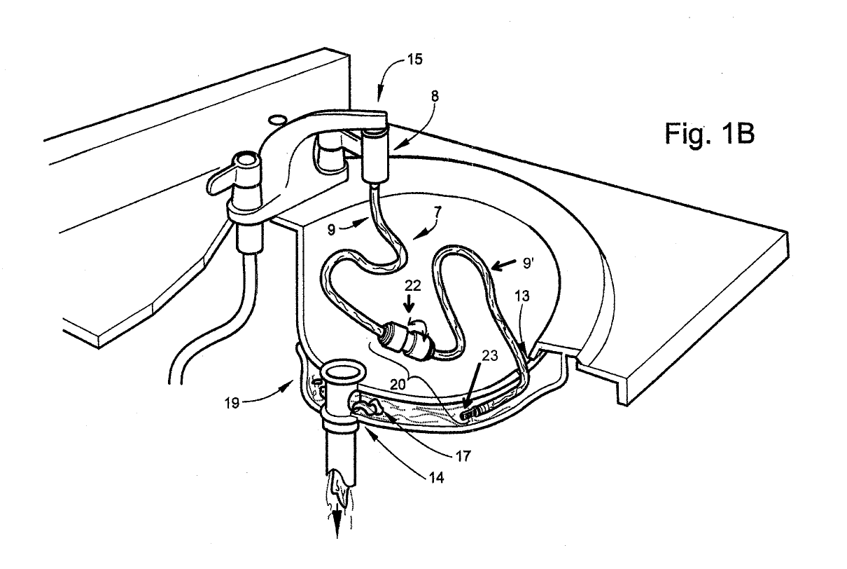

FIG. 1A schematically illustrates one example of an embodiment of a drain cleaning device 7 coupled with a faucet 15 and inserted into an overflow drain 13 and conduit 19. The drain cleaning device 7 includes a connecting adaptor 8, a primary flexible tube 9, and a rotating spray assembly 20. The connecting adaptor 8 can be coupled to a source of pressurized liquid, for example, a typical household faucet, and receives liquid flow therefrom. The source of pressurized liquid may include a threaded spout to which the connecting adaptor 8 can be threadably coupled. The connection adaptor 8 may be formed of common plumbing materials, for example, rigid plastic, copper, brass, and/or similar materials. While a threaded adaptor or connector is depicted, it should be appreciated that any other suitable connector or adaptor may be utilized to permit a fluid or liquid to flow into the described device, for example. Examples of connectors include elastic members, clips, slotted members, mechanical fasteners or fittings, and/or tubing that can stretch and fit securely to the source, etc.

In the illustrated embodiment, the faucet 15 includes a threaded spout (not shown) to which the connecting adaptor 8 is threadably coupled or connected to. The primary tube 9 may include, for example, a relatively long, hollow, flexible tube connected at one proximal end to the connecting adaptor 8 and connected at its other distal end to the rotating spray assembly 20. The primary tube 9 may include a flexible lumen that establishes fluid communication between the connecting adaptor 8 and the rotating spray assembly 20. The primary tube 9 can be made from any suitable material. For example, the material can be one that can be at least partially inserted into the conduit 19. For example, it can be a flexible material, for example, metal, plastic or rubber, which tends to hold its shape but without being so rigid as to not easily bend around the turns in a conduit or similar cavity. In some embodiments, but not limiting embodiments, such rigidity, flexibility and strength of the primary tube 9 can be contribute to ease of use.

In some embodiments, the rotating spray assembly 20 optionally can include, for example a rotating coupling 22, a secondary tube 9′, and an elongated spraying tip or nozzle 22. The rotating coupling 22 establishes fluid communication between the distal end of the primary tube 9 and the proximal end of the secondary tube 9′. While the terms “primary” and “secondary” are used to describe different portions of the tube member, it should be appreciated that a single tube can be used (as described more fully below) and the combined “tube member” can be referred to as the “tube,” the “tube member,” or by any other suitable term. The rotating coupling 22 can be further configured to allow the secondary tube 9′ to rotate relative to the longitudinal axis of the primary tube 9. The rotating coupling 22 includes mating portions on both ends of the coupling which are sized to accommodate the diameters of the primary tube 9 and the secondary tube 9′ to securely retain the tube ends even when liquid flows there through at a high pressure. In some embodiments, the primary tube 9 and secondary tube 9′ may have diameters of about one-quarter of an inch and may each be about 18 inches long, for example. For example, the tubes may have a diameter of between one-tenth of an inch and three-quarters of an inch. Also, for example, the length of one or both may be between 6 inches and 36 inches long or longer. It should be understood that different lengths and diameters can be used depending upon the configuration of the sink, the distance from the liquid source to the drain, the size of the drain opening, etc.

In various embodiments, the rotating coupling 22 can include, a male portion and a female portion. The female portion may receive the male portion to allow the two portions to axially rotate relative to one another. Both the male and female portions of the rotating coupling 22 receive liquid from the primary tube 9 and direct it through a hollow orifice or lumen that runs longitudinally through the coupling 22. The rotating coupling may be comprised of metal, metal alloy, plastic, and/or other suitable material(s).

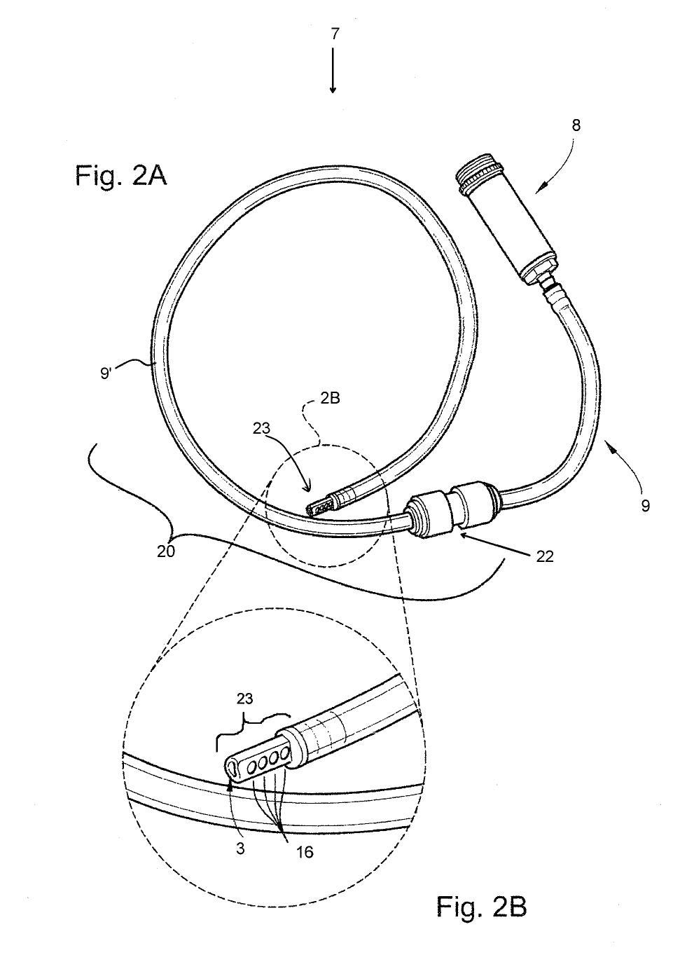

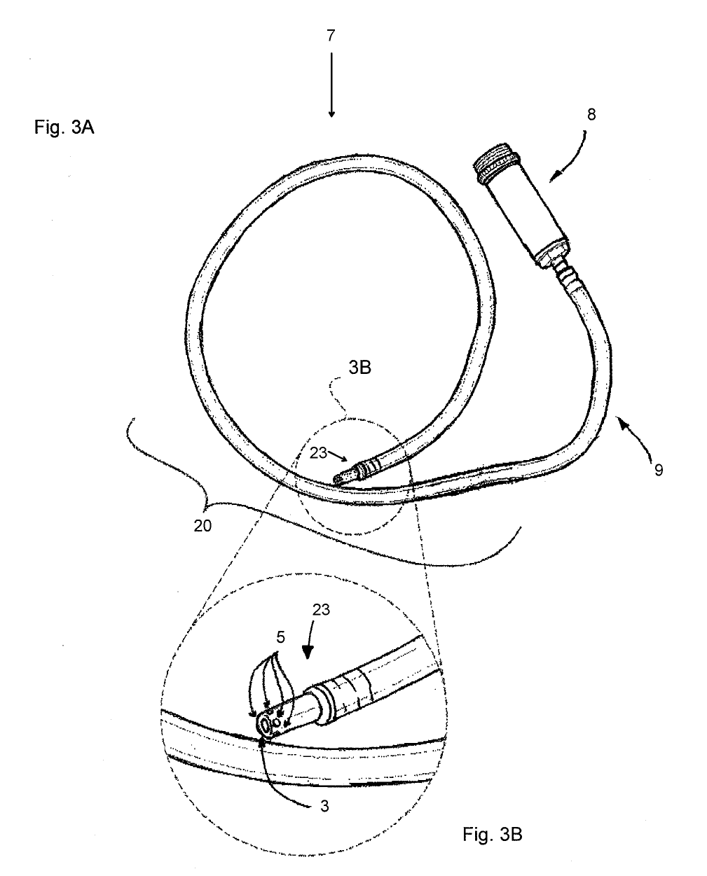

The spraying tip or nozzle 23 may be coupled to the distal end of the secondary tube 9′. The spraying tip 23 may emit a spray of liquid at a volume and/or velocity sufficient to dislodge debris or contaminants from the drain conduit 19. In some aspects the spraying tip or nozzle 23 may emit spray of a liquid at a relative high-velocity to clean away contaminants and/or residues residing within the overflow conduit 19. The spraying tip 23 may include, for example, metal, metal alloy, plastic, and/or other suitable materials. The spraying tip 23 may include an elongated body with a lumen or cavity formed therein. The lumen may have a uniform diameter or may taper across a length to increase the velocity of liquid passing there through. The lumen may include one or more apertures configured to emit, project, and/or spray liquid from the lumen. In one embodiment, an aperture may be formed at the distal end of the spraying tip 23 and be configured to emit liquid in a direction generally parallel to the longitudinal axis of the spray tip. In various embodiments, one or more apertures may extend along the sides of the spraying tip 23 to emit liquid from the lumen in a direction generally normal to the longitudinal axis of the spraying tip 23 as shown more clearly in FIGS. 2B and 3B. In some embodiments, the spraying tip 23 may include apertures of varying sizes and shapes positioned at various angles around the general circumference of the tip 23. In one embodiment, the apertures may be configured to project liquid from the tip 23 at an angle such that the projected liquid is directed at the conduit walls at an angle between about 15° and about 75°. The tip 23 may be force-fitted or otherwise secured to or over the end of the secondary tube 9′ to establish fluid communication from the secondary tube through the spraying tip 23.

Turning now to FIG. 1B, which shows a non limiting example of a device in use, the connecting adaptor 8 may be coupled to a source of pressurized liquid, for example, a sink faucet and the spraying tip 23 may be guided into one or more apertures in an overflow drain 13. The overflow drain 13 may lead to an overflow conduit 19 that is fluidly connected with a primary drain 14 or similar plumbing configured to direct liquid from the sink to another area. After the spraying tip 23 is inserted into the overflow drain 13, the flexible secondary tube 9′ may also be fed into the overflow conduit 19 so that the spraying tip 23 may reach a desired location in the conduit 19. Once the spraying tip 23 is inside the conduit 19, the source of pressurized liquid may be released into the drain cleaning device 7 as illustrated. In one embodiment, pressurized liquid may be introduced into the cleaning device 7 by turning a faucet or opening a valve. Liquid then flows freely through the device 7 and is sprayed or emitted from the apertures in the spraying tip 23 at a relatively high velocity. In some embodiments, liquid may be sprayed from the tip 23 in a forward direction and/or one or more transverse or lateral directions. The tip 23 may be maneuvered throughout the conduit 19 to clean residue or standing contaminants 17 from different portions of the conduit and flush these materials, along with the sprayed liquid, into the primary drain 14. In some embodiments, a user may rotate the secondary tube 9′ within the conduit 19 due to the rotating coupling 22. In some embodiments, the tip 23 may be rotated without a rotating coupling 22 due to the flexibility of the primary tube 9 or secondary tube 9′.

Turning now to FIG. 2A, a drain cleaning device 7 is schematically depicted, according to one embodiment. The drain cleaning device includes a connecting adaptor 8, a primary tube 9, and a spray assembly 20. Turning now to FIG. 2B, a close-up view of a portion of a non limiting example of a spray assembly 20 is illustrated. The spray assembly 20 includes a spray tip or nozzle 23 that is coupled to a secondary tube. The spray tip 23 may be configured to project, emit, or spray liquid provided from a high pressure liquid source at a relatively high velocity. The projected liquid may include water and/or a cleaning solvent and may be used to clean clogs, residues, and/or odors from overflow drains and conduits. As shown, the spray tip 23 includes a forward aperture 3 and a plurality of side facing apertures 16. The forward aperture 3 is configured to project liquid in one or more directions that are generally parallel to a longitudinal axis of the spray tip 23. The side facing apertures 16 are configured to project liquid in one or more directions that are generally not parallel to the longitudinal axis of the spray tip 23. For example, the side facing apertures 16 may be configured to project liquid at an angle that is generally perpendicular to the longitudinal axis of the spray tip 23 and/or at an angle that is about 45°, for example, relative to the longitudinal axis of the tip. In some embodiments, one or more rows of side-facing apertures 16 may be disposed longitudinally along the spray tip 23. The rows may each include any number of apertures 16, for example, 4. In some embodiments, the rows can be spaced about equally from one another over the circumference of the spray tip 23. The rows may be generally aligned with one another or offset from one another. The size, shape, and quantity of side-facing apertures 16 may vary from row to row or within a single row. In some embodiments, the tube 9′ and the spray tip 23 can be of the same material. For example, the tube and the tip can be a continuous material that terminates with a plurality of apertures as described herein, for example.

The forward aperture 3 and side facing apertures 16 may vary in size, shape, and/or angle relative to the longitudinal axis of the tip 23. For example, in various embodiments, the one or more of the apertures may be generally round, circular, curvilinear, polygonal, irregularly shaped, symmetric, and/or asymmetric. In one embodiment, the forward looking aperture 3 can be generally the same size as the side-facing apertures 16. In other embodiments, the side-facing apertures 16 are differently sized than the forward looking aperture 3. In some embodiments, a spray tip 23 may include more than one forward looking aperture 3. In some embodiments, the side-facing apertures 16 can be of different sizes and/or shapes.

Turning now to FIG. 3A, one example of an embodiment of a drain cleaning device is schematically depicted. The drain cleaning device includes a connecting adaptor 8, a primary tube 9, and a spray tip 23. As illustrated, the drain cleaning device includes a continuous primary tube 9 disposed between the connecting adaptor 8 and the spray tip 23. In some aspects the primary tube 9 may be sufficiently flexible to rotate relative to the connecting adaptor 8. The tube 9 may be of any suitable material, including for example, rubber, plastic, metal, polymer, combinations thereof and other like material. In some embodiments, the tube 9 and the spray tip 23 can be of the same material. For example, the tube and the tip can be a continuous material that terminates with a plurality of apertures as described herein, for example.

FIG. 3B is a close-up view of the spray tip 23 schematically depicted in FIG. 3A. The spray tip 23 includes a forward aperture 3 and a plurality of side-facing apertures 5. The forward aperture 3 and side-facing apertures 5 may vary in size, shape, and/or direction (e.g., angle relative to the longitudinal axis of the spray tip 23). In one embodiment, the side-facing apertures 5 may be equally spaced from one another over the circumference or perimeter of the spray tip 23. In one embodiment, the spray tip 23 may include 4 side-facing apertures 5 equally spaced from one another (e.g., at 90° increments from one another). The side-facing apertures 5 may vary from one another in size, shape, and/or direction. In some embodiments, a spray tip 23 may include more than one forward aperture 3.

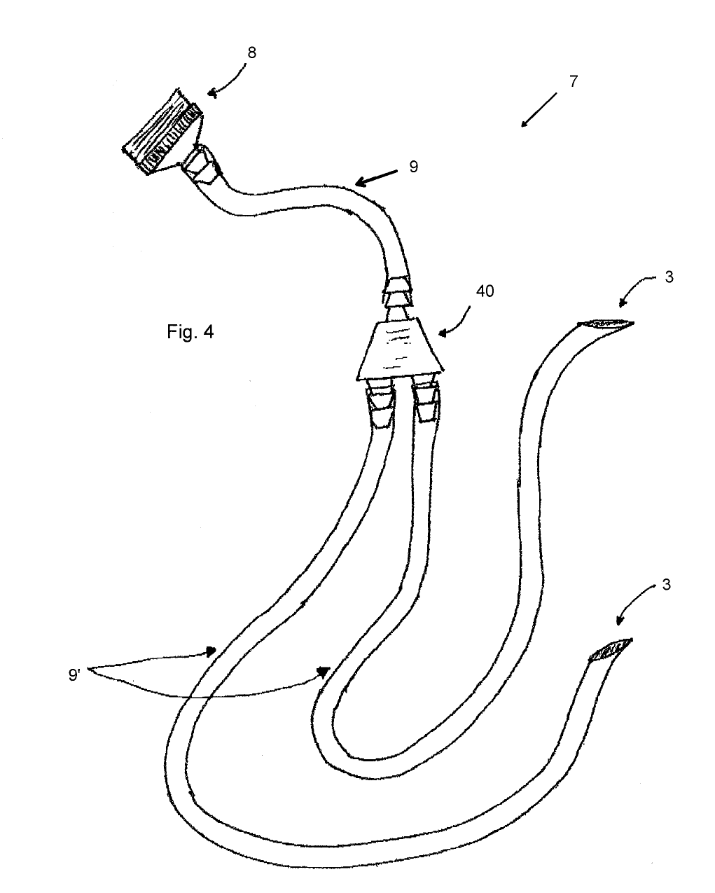

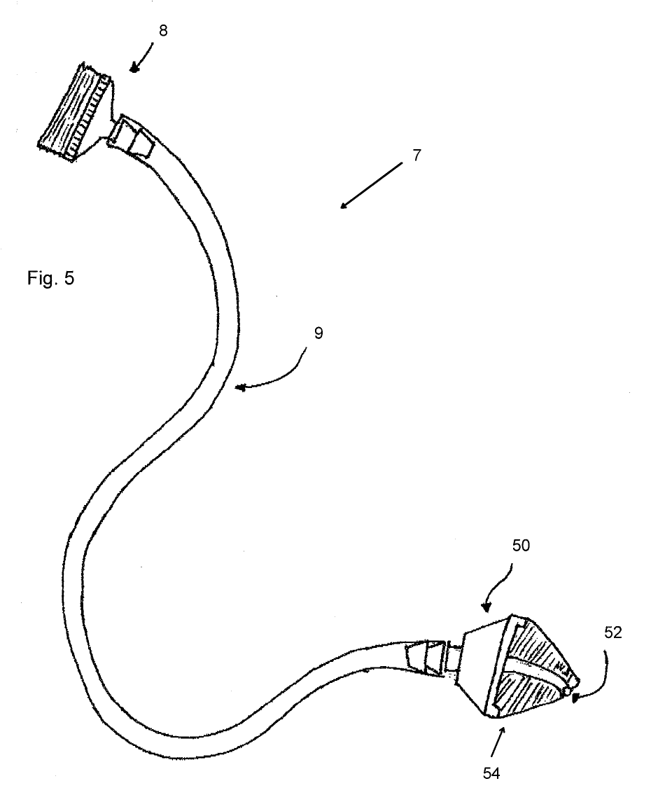

Another embodiment of a drain cleaning device can include a connection 40 for multiple secondary tubes 9′, as schematically depicted in FIG. 4. The connection 40 may be any of the common types of connectors or connections well known in the art, for example, a rigid cross with one inlet and three outlets. The number of outlets provided on the connection 40 may equal the number of secondary tubes 9′. If there are more outlets than tubes 9′, a stop or cap may be placed on the outlets that do not have a corresponding secondary tube 9′. The connection 40 may be configured to split the liquid travelling through the inlet equally among the outlets or may be configured to distribute different amounts of liquid to each outlet. In the illustrated embodiment, the distal ends 3 of each secondary tube 9′ may be cut at an angle, for example, 45°, to allow for the insertion of the tubes 9′ into smaller overflow drains or conduits. When there is more than one overflow drain or aperture in the sink, this configuration may be advantageous as a tube 9′ may be inserted into multiple drains or apertures to simultaneously clean different conduits. Although not depicted the tubes 9′ further can include tips for directing the liquid, for example, as described elsewhere herein.

Turning now to FIG. 5, another example of an embodiment of a drain cleaner 7 is schematically depicted. In one embodiment, the drain cleaner 7 includes a connecting adaptor 8, a primary tube 9, and a plugging and spraying assembly 50. The primary tube 9 may have a distal end and a proximal end with the proximal end coupled to the connecting adaptor 8 and the distal end coupled to the plugging and spraying assembly 50 such that fluid communication is established between the connecting adaptor 8 and plugging and spraying assembly 50.

The plugging and spraying assembly 50 may include a plugging surface 54 and a spraying tip 52 that is fluidly connected to the primary tube 9. The spraying tip 52 may taper or have a diameter substantially less than the primary tube 9 such that liquid travels there through at a relatively higher velocity than through the primary tube 9. The plugging surface 54 may be tapered and configured to fit at least partially within a drain aperture, for example, an overflow drain, to create a seal between the plugging surface 54 and the edges of the overflow drain or aperture. In some embodiments, the plugging surface 54 can include a pyramid, cone, or frustum (e.g., a truncated cone or pyramid). The spraying tip 52 may be inserted at least partially into an overflow drain or aperture to clean contaminants or residues therein by projecting liquid into the cavity. The illustrated embodiment may be advantageous when the overflow conduit is not large enough to accommodate a larger spraying tip or tube. The plugging surface 54 and spray tip 52 may be made, for example, of rubber or another resilient material such that a portion of the surface 54 can be force-fitted into a drain or aperture to create a substantial seal and/or prevent the egress of liquid from the overflow conduit into the sink or container.

The foregoing description details certain embodiments of the devices and methods disclosed herein. It will be appreciated, however, that no matter how detailed the foregoing appears in text, the devices and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated. The scope of the disclosure should therefore be construed in accordance with the appended claims and any equivalents thereof.

It will be appreciated by those skilled in the art that various modifications and changes may be made without departing from the scope of the described technology. Such modifications and changes are intended to fall within the scope of the embodiments, as defined by the appended claims. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An overflow conduit cleaning device, comprising:
a tube comprising a distal end and a proximal end, the tube being formed of a flexible material and having a lumen running from the proximal end to the distal end;
a connecting adaptor coupled to the proximal end of the tube and configured to establish fluid communication between a source of liquid and the lumen; and
a spray tip having a longitudinal axis and an internal cavity with at least one aperture connecting the internal cavity with a surface of the spray tip, the spray tip being coupled with the distal end of the tube to establish fluid communication between the lumen and the internal cavity, wherein the at least one aperture is configured to project liquid provided by the source of liquid out of the spray tip.

2. (canceled)

3. The overflow conduit cleaning device of claim 1, wherein the tube has an outer diameter of about one-quarter of an inch.

4. (canceled)

5. The overflow conduit cleaning device of claim 1, wherein the connecting adaptor is configured to threadably engage a spout.

6. (canceled)

7. (canceled)

8. The overflow conduit cleaning device of claim 1, wherein the spray tip and connector adaptor comprise the same material.

9. The overflow conduit cleaning device of claim 8, wherein the tube and connector adaptor comprise the same material.

10. The overflow conduit cleaning device of claim 1, wherein the pressurized source of liquid comprises a faucet.

11. The overflow conduit cleaning device of claim 1, wherein the spray tip comprises as least one forward aperture and at least one side-facing aperture.

12. The overflow conduit cleaning device of claim 11, wherein the at least one side-facing aperture is configured to project liquid from the internal cavity in a direction that is generally normal to the longitudinal axis.

13. The overflow conduit cleaning device of claim 11, wherein the at least one side-facing aperture is configured to project liquid from the internal cavity at an angle that is between about 15° and about 75° relative to the longitudinal axis.

14. The overflow conduit cleaning device of claim 11, wherein the spray tip comprises a plurality of side-facing apertures that are generally aligned with one another about the longitudinal axis.

15. The overflow conduit cleaning device of claim 14, wherein the plurality of side-facing apertures are generally equally spaced around a perimeter of the spray tip.

16. The overflow conduit cleaning device of claim 1, wherein the spray tip has a diameter that is less than about one quarter of an inch.

17. (canceled)

18. (canceled)

19. The overflow conduit cleaning device of claim 1, further comprising a rotating coupling configured to permit rotation of at least a portion of the tube relative to the connecting adaptor.

20. An overflow drain cleaning device, comprising:
a first means for directing a liquid from one location to another location;
a second means for connecting the first means to a source of pressurized liquid; and
a third means for projecting liquid from the first means.

21. A drain cleaning apparatus, comprising:
a primary tube comprising a distal end and a proximal end;
a connecting adaptor coupled to the proximal end of the primary tube and configured to establish fluid communication between a pressurized source of liquid and the primary tube;
a connector comprising an inlet and a plurality of outlets, the connector configured to evenly distribute a liquid input into the inlet between the plurality of outlets,
a plurality of secondary tubes, each secondary tube having a longitudinal axis, a first end, and a second end, the first end of each secondary tube being coupled to an outlet to establish fluid communication between the secondary tube and the connector, the second ends of each tube comprising an aperture that is disposed on a plane that lies at an angle relative to the longitudinal axis.

22. The drain cleaning apparatus of claim 21, wherein the quantity of outlets is equal to the quantity of secondary tubes.

23. The drain cleaning apparatus of claim 21, wherein there are two (2) secondary tubes.

24. The drain cleaning apparatus of claim 21, wherein the second end of each secondary tube comprises an aperture that is disposed on a plane that lies at an angle of about 45° relative to the longitudinal axis of the secondary tube.

25. The drain cleaning apparatus of claim 21, further comprising a plurality of spray tips each having an internal cavity with at least one projectile aperture connecting the internal cavity with a surface of the spray tip, each spray tip being coupled with a second end of a secondary tube, wherein fluid communication is established between the secondary tubes and the spray tips.

26. (canceled)

27. (canceled)

28. A method of cleaning an overflow conduit, comprising:
providing a device or apparatus according to claim 1;
inserting at least one spray tip into an overflow drain opening; and
providing a fluid into the device at a flow or velocity such that the fluid is projected from the at least one spray tip in a plurality of directions.
